(19) United States
(12) Patent Application Publication
(10) Pub. No.: US 2007/0152383 A1
(43) Pub. Date: Jul. 5, 2007

(54) Continuous cutting and drilling lance

(76) Inventor: Hugo Salamanca, Santiago (CL)

Correspondence Address: Hugo Salamanca P., Av. Suecia 84, Oficina 43, Providencia, Santiago, CL

(21) Appl. No.: 11/595,961

(22) Filed: Nov. 13, 2006

Related U.S. Application Data
(60) Provisional application No. 60/734,965, filed on Nov. 10, 2005.

(51) Int. Cl. B23K 7/00

(52) U.S. Cl. 266/48

(57) ABSTRACT

This invention refers to a new drilling and cutting system. This new drilling and cutting system is based on the production of a controlled and localized iron oxidation reaction with oxygen as a comburent and the iron as the fuel, through a continuous feeding with the resulting localized zone of high temperature (focus) which allows to cast the material to be drilled or cut. The system is composed by the nozzle which is intended to guide the iron and oxygen, which come from different paths, to the focus in which the oxidation reaction takes place. The liner is intended to guide the oxygen and the iron through different paths from the tractor system to the nozzle. The tractor system is intended to continuously feed the iron to the system, Iron deposit, Iron advance control, Oxygen feeding control and Oxygen dispenser.

### CROSS-REFERENCE TO RELATED APPLICATIONS

This application claims the benefit of provisional patent application Ser. No. 60/734,965 filed Nov. 10, 2005 by the present inventor

### FEDERAL SPONSORED RESEARCH

Not Applicable

### SEQUENCE LISTING OR PROGRAM

Not Applicable

### BACKGROUND

1. Field of Invention

This invention relates to a new drilling and cutting system, of any material operating environment, atmosferic, vacuum or undersea.

2. Prior Art

Continuous lances have been developed for the cutting and drilling of any material of great thickness and irrespective of the operating environment, atmospheric, vacuum or undersea. They allows for the drilling of bleeding plates from smelting furnaces of the different smelting processes of copper, nickel, iron or any other metal, and for the drilling of concrete walls, ship hulls even if they are undersea, cutting of stainless steel sheets, accretions of any type inside the smelting furnaces, to cut pavement and rock, in an economic, safe and fast way.

At present, the cutting processes are based on the following methods: 1) Oxidation cut, in which the element is heated with a flame by using fuel gas until certain temperature is reached, then it is subjected to an additional flow of oxygen which violently oxides the material provoking a fast cut. 2) Plasma cut, in which through an electric arch a gas is heated which is ionized and influences the conducting material, whether ferrous or non ferrous, to make the cut. Water pumped through a nozzle at high speeds provoking a high kinetics energy which is focalized at a point to carrying out the cut. 2) Laser cut, in which a light beam is concentrated through crystals impacting the surface which is crossed by the concentrated energy on such beam. The oxifuel allows the greatest thickness but they must be conductors, water is useful for all the materials but it is limited by the thickness, laser requires high energy for not a great thickness.

### SUMMARY

A continuous lance which cuts or drills any material comprising a nozzle, a liner, a tractor system, an advance control system, an oxygen flow control system, an iron deposit, and oxygen dispenser unit wherein it is a cutting and drilling methodology based on the exothermal reaction of iron in which the cutting nozzle injects through separated places, iron and oxygen to produce an exothermal reaction in the outside and it is attached to the liner so as to generate a continuous controlled and localized high temperature focus and where the lance is not worn by the reaction.

### DRAWINGS—FIGURES

In the drawings, closely related figures share the same numbers, with different alphabetic suffixes.

FIG. 1. General view of the continuous lance layout and its components.

FIG. 2. General view of the nozzle, perforations, wire and the liner.

### DRAWINGS—REFERENCE NUMERALS

1. Nozzle

2. Liner

3. Tractor system

4. Feeder speed control

5. Oxygen flow control

6. Iron deposit

7. Oxygen dispenser

8. Iron wire

9. Perforations

### DETAILED DESCRIPTION

This invention refers to a new system for the drilling and cutting of any material, which is based on the production of a controlled and localized iron oxidation reaction through a continuous feeding. A localized zone of high temperature (focus) is reached allowing to cast the material to be drilled or cut.

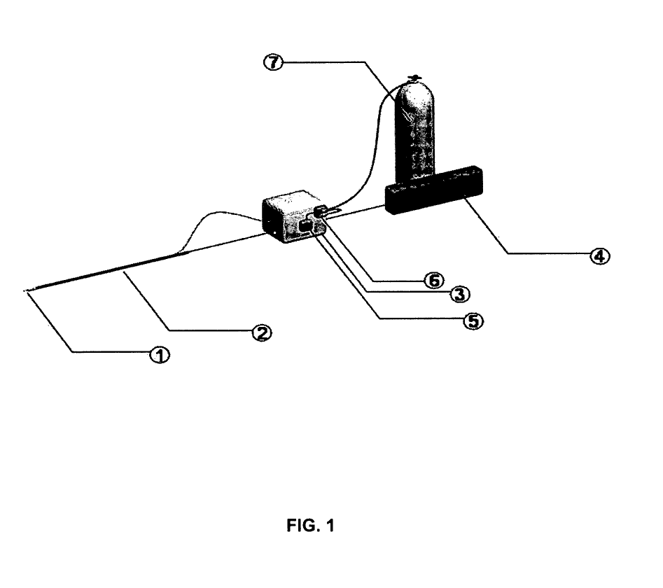

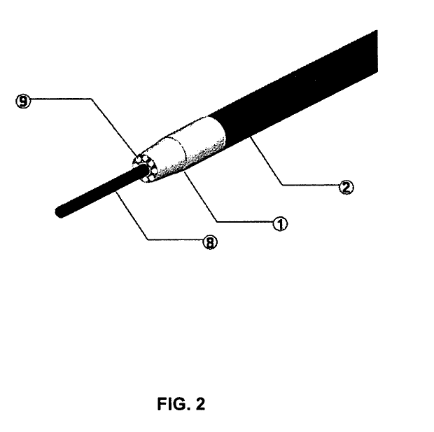

With reference to FIG. 1 and FIG. 2, The drilling and cutting system of any material consists of a Continuous Lance comprising a Nozzle (1) which is a final element though which the wire (8) and the oxygen go out, producing an exothermal reaction outside in order to protect it. The liner (2) is the element which is coupled to the nozzle (1) wich allows the wire (8) to enter and the oxygen to be injected through the perforations (9). The Tractor System (3) is the system which allows the injection of the wire (8) to the nozzle (1) through the liner (2). The feeding speed control (4) allows to control the energy of the lance varying the wire injection speed (8). The oxygen flow control (5) allows to keep the stechiometric reaction between the oxygen and the iron, adjusting to the new requirements of energy provided by the advance speed of the wire (8). The iron deposit (6) is the unit in which the iron is stored and removed on a continuous basis. The oxygen dispenser (7) is the storing and dispenser unit of gaseous oxygen for the reaction.

In this way the Continuous cutting Lance is the set of elements that allow to feed the iron and the oxygen to the nozzle (1) to produce the desired cut.

I claim:

1. A continuous lance which cuts or drills any material comprising a nozzle, a liner, a tractor system, an advance control system, an oxygen flow control system, an iron deposit, and oxygen dispenser unit wherein it is a cutting and drilling methodology based on the exothermal reaction of iron in which the cutting nozzle injects through separated places, iron and oxygen to produce an exothermal reaction in the outside and it is attached to the liner so as to generate a continuous controlled and localized high temperature focus and where the lance is not worn by the reaction.

2. A continuous lance for drilling and cutting any material according to claim 1, wherein it has a continuous controlled and localized high temperature focus based on the exothermal reaction of iron.

3. A continuous lance for drilling and cutting any material according to claim 1, wherein it is a cutting and drilling methodology in the exothermal reaction where the lance is not worn by the reaction.

4. A continuous lance for drilling and cutting any material according to claim 1, wherein it has a cutting nozzle which injects through separated places iron and oxygen to produce an exothermal reaction in the outside and it is attached to the liner.

5. A continuous lance for drilling and cutting any material according to claim 1, wherein the liner is attached to the nozzle and allows to conduct the wire and oxygen.

6. A continuous lance for drilling and cutting any material according to claim 1, wherein the tractor system allows to inject iron to the nozzle through the liner in order to feed the reaction and which is connected to the iron deposit in order to take it reaching a continuous feeding.

7. A continuous lance for drilling and cutting any material according to claim 1, wherein the advance control allows to vary the energy of the reaction by acting over the wire feeding speed and it is connected to the tractor system.

8. A continuous lance for drilling and cutting any material according to claim 1, wherein the oxygen flow control when interlocking to the advance speed control, allows to adjust the oxygen according to the wire quantities so as to keep the stechiometric relationship of the reaction.

9. A continuous lance for drilling and cutting any material according to claim 1, wherein it has an iron deposit from which the tractor system feeds according to the requirements.

10. A continuous lance for drilling and cutting any material according to claim 1, wherein it has an oxygen dispenser which provides gaseous oxygen for the reaction.

11. A continuous lance for drilling and cutting any material according to claim 1, wherein it allows the punching of exit passages of the smelting furnaces of different smelting processes of copper, nickel, iron or any other material, for the drilling of concrete walls, ship hulls even undersea, the cutting of stainless steel sheets, accretions of different types inside the smelting furnaces, to cut pavement and rock.

12. A continuous lance for drilling and cutting any material according to claim 1, wherein it could be operated manually, semi-automatically or automatically, remotely, in order not to expose the operator to the risks of particle projection.
